(19) United States
(12) Patent Application Publication
(10) Pub. No.: US 2004/0203762 A1
(43) Pub. Date: Oct. 14, 2004

(54) Operating an ad-hoc wireless network in one or more regulatory regions

(76) Inventors: Jiewen Liu, San Diego, CA (US); Chih C. Tsien, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/272,141

(22) Filed: Oct. 15, 2002

(51) Int. Cl. H04Q 7/20

(52) U.S. Cl. 455/434; 455/422.1

(57) ABSTRACT

A mobile unit may operate within an ad-hoc network by listening for information broadcast from a device on the network pertaining to regulatory information. If the mobile device receives regulatory information, the transmitter of the mobile unit may be arranged to transmit within regulatory restrictions. If no regulatory information is received after a predetermined period, the transmitter of the mobile unit may be arranged to transmit at a predetermined safe power level on a clear channel in a common frequency band. The predetermined safe power level may be determined to be in compliance with a known regulatory restriction.

### BACKGROUND OF THE INVENTION

Regulations setting restrictions on wireless communications have been established in various regions. Such regulations may vary across jurisdictions and dictate power level and frequency ranges at which a wireless device may safely or legally operate. Standards for wireless local area networks (LANs) such as standards promulgated by the Institute of Electrical and Electronics Engineers (IEEE), for example an IEEE 802.11 standard, may not specify the processes for establishing ad-hoc networks, including how to comply with local regulations, so various implementations may exist for operating wireless devices according to a particular wireless network standard. Typically, wireless LAN products may implement one or more various processes for establishing an ad-hoc network in which devices communicate directly with other devices without requiring an intermediary device such as a base station or access point. In a first typical process, no particular regulation may be adhered to or taken into consideration wherein direct transmission may be initiated using active scanning until a network is found. In another process, devices may passively scan for a network and listen for broadcast regulation information before starting an ad-hoc network according to the received regulation information. In a third process, the user may select and enter the regulation information into a device, and then the device may operate according to the information entered by the user.

There are several problems with the above mentioned processes for establishing an ad-hoc network. For example, using the first method may result in a clear violation of regulatory restrictions whenever operating in a controlled regulatory region, since transmission at least initially occurs without regard to any regulated communication restrictions. Using the second method, devices may not establish a network if no regulation information is detected. Using the third method, a regulation may be violated in the event the user inputs the wrong information, or if the regulation information known to the user is incomplete or out of date. In addition, there may exist the possibility that a user could intentionally violate a regulation via manual selection of broadcast parameters.

### DESCRIPTION OF THE DRAWING FIGURES

The invention may be understood by reference to the following description taken in conjunction with the accompanying drawings in which like reference numerals identify like elements, and in which:

FIG. 1A is a block diagram of a communication system in accordance with one embodiment of a wireless LAN infrastructure based services set network

FIG. 1B is a block diagram of a communication system in accordance with one embodiment of a wireless LAN independent based services set network.

FIG. 2 is a block diagram of a portable device that may be utilized in the communications system of FIG. 1, in accordance with an embodiment of the present invention.

FIG. 3 is a diagram of a flow chart that illustrates a method to operate a communications device in accordance with an embodiment of the present invention.

FIG. 4 is an example graph of a safe power mode link versus data rate for a device operating on an ad-hoc network in accordance with an embodiment of the present invention.

FIG. 5 is an example plot of a safe power emission level versus distance for a device operating on an ad-hoc network in accordance with an embodiment of the present invention.

### DETAILED DESCRIPTION

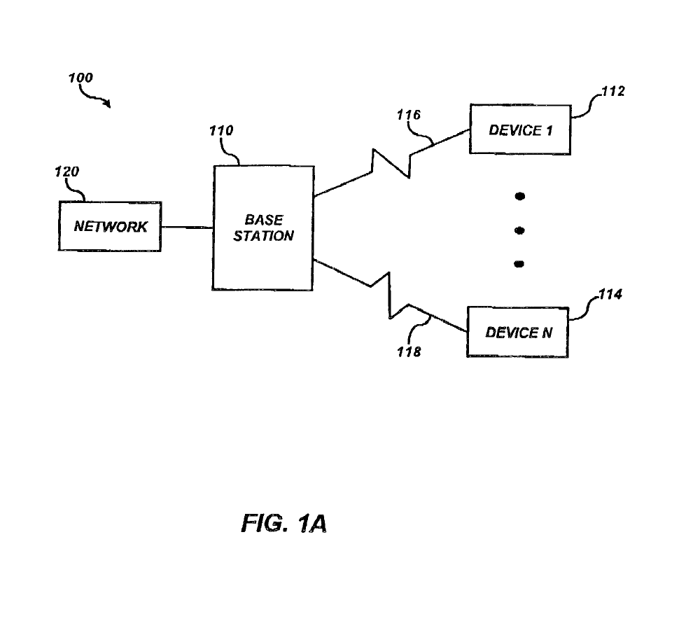

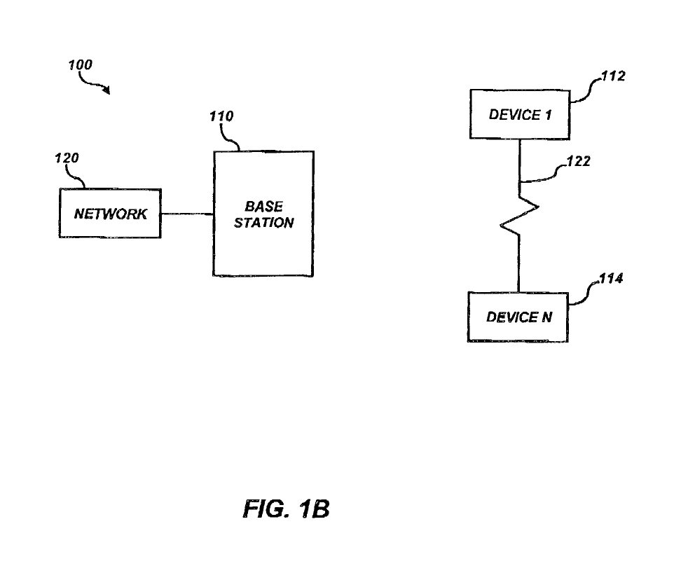

Referring now to FIG. 1A, a block diagram of a communications system in accordance with an embodiment of present invention will be discussed. In one embodiment, communications system 100 may include a base station 110 that communicates with one or more devices 112-114, over one or more communication links 116-118. In one embodiment, at least one or more of communications links 116-118 may be a wireless link, such as a radio-frequency communications link in a cellular telephone network or a wireless local area network, although the scope of the present invention is not limited in this respect. Devices 112-114 may be wireless phones, personal digital assistants, computers, pagers, portable music players, or any other device capable of communicating with base station 110 via at least one or more communication links 116-118, although the scope of the present invention is not limited in this respect.

In one embodiment, in a wireless LAN, devices 112 and 114 may communicate with one another in an Infrastructure mode, also known as a Based Services Set (BSS) mode. In such an embodiment, devices 112 and 114 may communicate with base station 110 which may be arranged to operate as an access point for devices 112 and 114 to couple to network 120. When communications system 100 is arranged in a BSS mode, devices 112 and 114 may communicate with other devices 112 and 114 via base station 110, although the scope of the invention is not limited in this respect.

In another embodiment, as shown in FIG. 1B, in a wireless LAN, devices 112 and 114 may communicate with one another in an Independent Based Service Set (IBSS) mode, also known as an ad-hoc mode. When communications system 100 is arranged in an IBSS mode, devices 112 and 114 may communicate directly with one another by communicating via wireless link 122. In such an embodiment, devices 112-114 are not required to communicate with one another via communication links 116 and 118 via base station 110 as shown in FIG. 1A. Instead, devices 112-114 may communicate with other devices 112-114 via an ad-hoc network established via direct wireless link 122, although the scope of the invention is not limited in this respect. In one embodiment of the invention, devices 112-114 are optionally capable of communicating with one another via communication links 116-118 via base station 110 in a BSS network.

In one embodiment, at least one or more of devices 112-114 may be transportable by a user, such as a hand held device, and may be operated by a user while being hand held or otherwise on the person of the user, such as in a pocket, attached to a belt or holster, and so on. Base station 110 may allow devices 112-114 to communicate with other devices 112-114, and may allow devices 112-114 to communicate via network 120. In one embodiment, network 120 may be a wide area network or world wide network such as the Internet, although the scope of the present invention is not limited in this respect. As a transportable device, devices 112-114 may be referred to as mobile units (MUs).

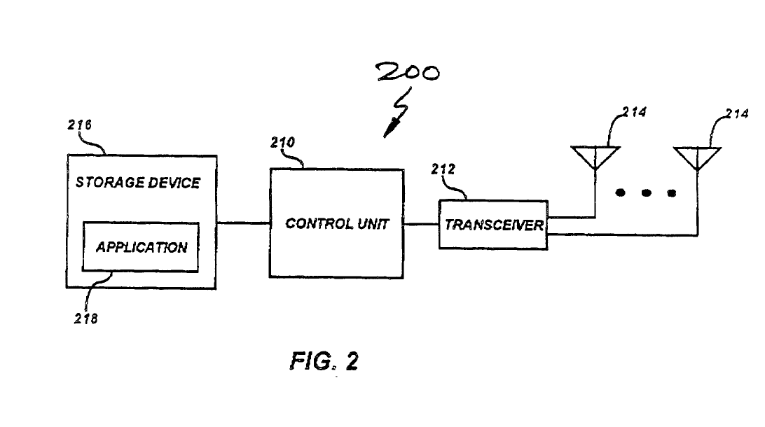

Referring now to FIG. 2, a block diagram of a communications device in accordance with an embodiment of the present invention will be discussed. Communications device 200 may be at least a portion of the architecture of base station 100 or one or more of devices 112-114. Base station 110 or devices 112-114 may include the components as shown in FIG. 2, and alternatively base station 110 or devices 112-114 may also include more or fewer components without altering the scope of the invention. Communications device 200 may include a control unit 210 to control the operation of communications device 200. Control unit 210 may include a microprocessor or a controller, although the scope of the present invention is not limited in this respect. A transceiver 212, and optionally included one or more antennas 214, couple with control unit 210 so that communications device 200 may communicate with other devices such as base station 110 via a wireless communication link 116-118. Also devices 112-114 may communicate via wireless communication link 122 in an ad-hoc mode.

In one embodiment of the invention, although not necessarily all, a storage device 216 may couple to control unit 210 to store an application 218, and also data or other information. Storage device 216 may include a memory device such as semiconductor memory, for example random access memory (RAM), flash memory, a disk drive, or the like, although the scope of the invention is not limited in this respect. In one embodiment, communications device 200 may include a storage device 216 on which an application 218, commands, or data may be stored. In one embodiment, an application, a command, or data may be received from base station via at least one or more of communication links. In one particular embodiment, an application 218 may be a arrangement application to arrange the operation of one of the portable devices. In one embodiment, the arrangement information may define one or more operating characteristics of the portable device, and may include at least a portion of an operating system, protocol stack, or standard application layer. In one embodiment, the arrangement information may be a software upgrade that defines one or more features of the portable device. The arrangement information may be, for example, retrieved from a database of a remote device or system coupled to base station. In a particular embodiment, application 218 may be an application for establishing communications via an ad-hoc network in accordance with an embodiment of the present invention, although the invention is not limited in this respect.

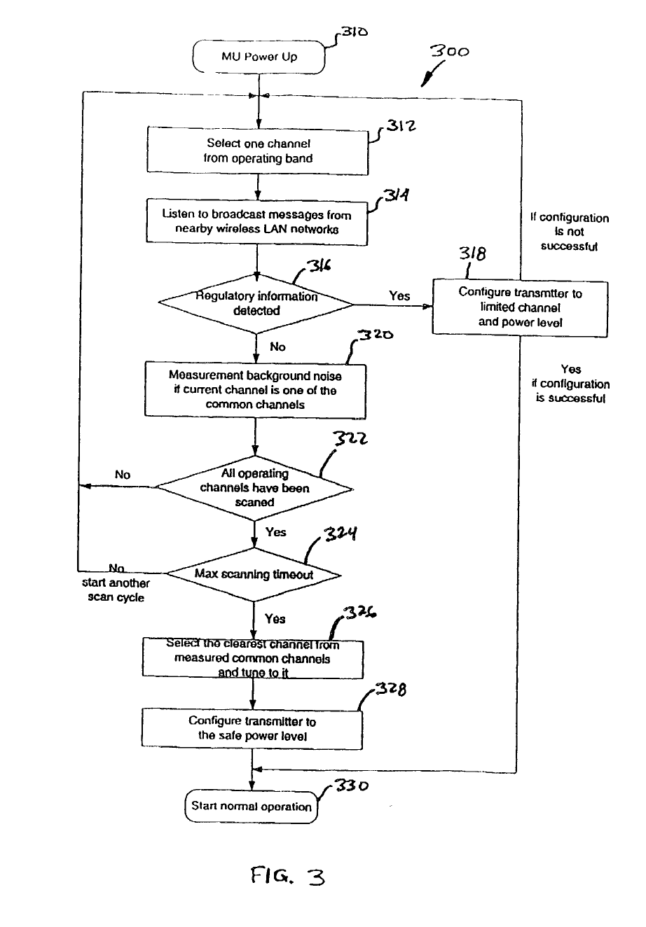

Referring now to FIG. 3, an example flow chart of a method to operate a device on an ad-hoc network in accordance with an embodiment of the present invention will be discussed. The method 300 shown in FIG. 3 may initiate with the powering up of a mobile unit at block 310. Method 300 may comprise, for example, a software application 218 stored in a storage device 216 executing on a mobile unit. The mobile unit may select one channel from an operating band, for example at a 5.2 GHz frequency band, at block 312, although the scope of the invention is not limited in this respect. The mobile unit may listen to messages broadcast from nearby wireless LAN networks at block 314. The mobile unit may listen to broadcast messages from other devices in the channel, for example base station 110, from a proximate IEEE 802.11 compliant wireless LAN, including, for example, infrastructure BBS and independent BBS networks, although the scope of the invention is not limited in this respect.

A determination may be made at block 316 whether any regulatory information is detected by the mobile unit. At block 316, devices may connect with base station 110 in a BSS mode, prior to connecting in an ad-hoc mode, to detect regulatory information that may be stored within base station 110. Base station 110 may store regulatory information that may indicate allowed frequency settings and power level settings for communicating in an ad-hoc mode, even though devices 112-114 form an ad-hoc network, devices 112-114 may adapt regulatory information from any nearby BSS or IBSS network. In event regulatory information is detected, the mobile unit may arrange its transmitter at block 318 to a transmitting setting, including a power level and channel, according to the detected regulatory information. A transmission setting may include at least one of a power level setting and a frequency or channel setting, although the scope of the invention is not limited in this respect. For example, if regulatory information such as country code, valid channels, and maximum transmitting power level, is detected from a received message, the mobile unit may arrange its radio accordingly and may start normal operations within the specified regulatory limitations. If the arrangement at block 318 is not successful, method 300 may continue at block 312, for example by selecting an alternative channel from the operating band. Otherwise, if the arrangement at block 318 is successful, the mobile unit may start normal operation at block 330.

In the event no regulatory information is detected at block 316, the mobile unit may measure background noise at block 320 if the current channel is a channel in a common band. In one embodiment of the invention, the common band may be 5.15 to 5.25 GHz for indoor communications, since most regulatory domains cover this band, and the common channel may be one or more of channel 36, channel 40, channel 44 and channel 48, although the scope of the invention is not limited in this respect. In another embodiment of the invention, wireless local area network 100 may operate at around 2.4 GHz, selecting a safe power level as appropriate. The background noise measurement may provide a picture of the frequency usage environment, which may be utilized for channel selection when all channels of the common band have been scanned, for example by selecting a clear channel. As an example, the link quality of four channels may be measured, for example using a receiver signal strength indication (RSSI) measurement. The results of the RSSI measurements may be −60 dBm on a first channel, −65 dBm on a second channel, −50 dBm on a third channel, and −70 dBm on a fourth channel. In such an example, the third channel having a −50 dBm RSSI measurement may be determined as being the clearer channel since it has the greatest receiver signal level. As a result, channel three may be selected for communications. A determination may be made at block 322 whether all channels in the operating band have been scanned by the mobile unit for regulatory information. In the event that less than all of the operating channels have been scanned, the method may continue at block 312 with other alternatively selected channels in the selected operating band.

In the event that all of the channels in the operating band have been scanned, a determination may be made at block 324 whether a predetermined scanning timeout, for example a maximum scanning timeout, has occurred. In the event a scanning timeout has not occurred, method 300 may continue at block 312 for one or more additional scan cycles in the operating band. If a scanning timeout has occurred, one of the more clear channels within the common band as determined at block 320 may be selected, and the transmitter of the mobile unit may be tuned to the clear channel. A clearer channel in the common band shall be selected in order to avoid frequency interference. Selection of a clearer channel may occur automatically based on channel measurements in order to reduce regulation violation events, although the scope of the invention is not limited in this respect.

The transmitter of the mobile unit may be arranged to operate at a predetermined transmission setting, for example at a predetermined a safe power level using a clear or a clearer channel, at block 328, and the mobile unit may start normal operation at block 330, for example by communicating via an ad-hoc network in an ad-hoc mode, although the scope of the invention is not limited in this respect. In one embodiment of the invention, a safe power level may be approximately 5 dBm for an indoor open or semi-open area, although the scope of the invention is not limited in this respect. Thus, if regulatory information is not detected within a predetermined time period in which most or all operating channels have been scanned, the mobile unit may select a clearer or the clearest channel in the common band, may arrange its radio to a predetermined safe power level, and may start normal operation and transmissions, although the scope of the invention is not limited in this respect.

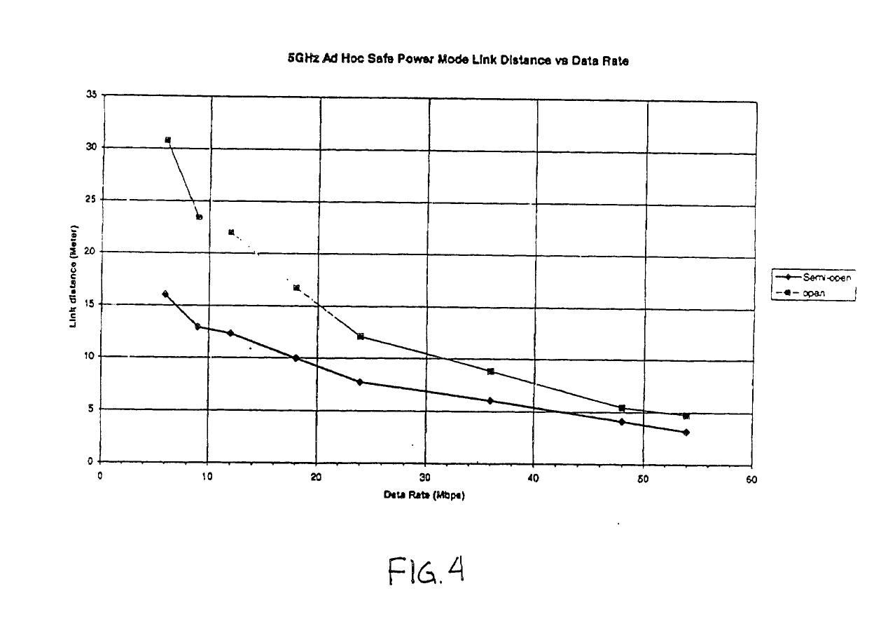

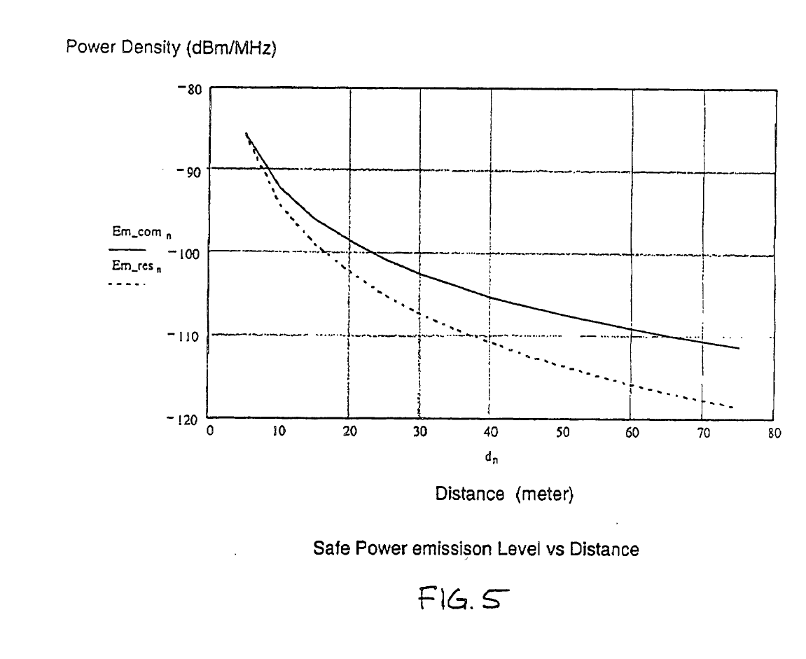

Referring now to FIGS. 4 and 5, graphs of an example performance of a device operating on an ad-hoc network in accordance with an embodiment of the present invention will be discussed. The mobile unit may be arranged to operate at a predetermined safe power level, such as shown at block 328 of FIG. 3, to ensure the transmitting power level of the mobile unit may not exceed a limit defined by regulatory domains in the event no regulatory information is detected, for example at block 316. For example with an IEEE 802.11a wireless LAN, a common band may be 5.15 GHz to 5.25 GHz for indoor communications since most regulatory domains cover this band, for example the USA and CEPT. A common channel may be, for example, channel 36, channel 40, channel 44, or channel 48, and a predetermined safe power level may be 5 dBm. As shown in FIG. 4, using a safe power level of 5 dBm, in an indoor open area or a semi-open area, satisfactory coverage may be provided such as 10 meters at data rate of 24 Mbps. Such coverage may be sufficient for a typical ad-hoc, IBSS network. As shown in FIG. 5, a predetermined safe power level emission may be low, for example at 5 meters away from the mobile unit the emission level may be around −85 dBm/MHz, which is well below an Federal Communications Commission (FCC) specified limit of −41 dBm/MHz. Thus, in one embodiment of the invention, a predetermined safe power level may be selected to be lower than a power level specified by a regulatory domain such as the FCC, and it may always be safe even though the regulator region Is not covered within a common band, although the scope of the invention is not limited in this respect.

Although the invention has been described with a certain degree of particularity, it should be recognized that elements thereof may be altered by persons skilled in the art without departing from the spirit and scope of the invention. It is believed that the method and system of operating an ad-hoc wireless network in one or more regulatory regions of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

What is claimed is:

1. A method, comprising:
establishing communications in a local area network;
arranging a transmission setting of a device based at least in part on regulatory information broadcast from the local area network if received from the network; and
otherwise arranging a transmission setting of the device to a safe transmission setting.

2. A method as claimed in claim 1, further operating the device within a limit specified by the regulatory information.

3. A method as claimed in claim 1, said otherwise arranging including arranging a transmission setting of a device based at least in part on a predetermined safe power level in a common band.

4. A method as claimed in claim 1, said otherwise arranging including scanning channels of a current operating band for regulatory information received from the local area network for a predetermined period, arranging a transmission setting of a device based at least in part on regulatory information broadcast from the local area network, and operating the device within a limit specified by the regulatory information.

5. A method as claimed in claim 1, said otherwise arranging including scanning channels of a current operating band for regulatory information received from the local area network for a predetermined period, measuring a background noise on common channels during said scanning, arranging a transmission setting of a device based at least in part on regulatory information broadcast from the local area network, and operating the device within a limit specified by the regulatory information.

6. A method as claimed in claim 1, said otherwise arranging including selecting a clearer channel within one or more common channels, arranging a transmission setting of a device to operate on the selected clearer channel, and arranging a transmission setting of a device based at least in part on a predetermined safe setting in the event regulatory information is not received from the local area network.

7. A method as claimed in claim 1, said otherwise arranging including arranging a transmission setting of a device based at least in part on a predetermined safe setting in the event regulatory information is not received from the local area network, selecting a safe power level corresponding to a selected channel, and arranging a transmission setting of the device to be within the safe power level.

8. A method, comprising:
scanning for regulatory information broadcast from a local area network;
in the event regulatory information is received, arranging a transmitter to operate within a limit specified by the regulatory information; and
otherwise arranging the transmitter to operate within a predetermined safe power level.

9. A method as claimed in claim 8, wherein said otherwise arranging occurs after a predetermined time interval.

10. A method as claimed in claim 8, further comprising, measuring a background noise of channels scanned during said scanning, said otherwise arranging including arranging the transmitter to operate on a clearer channel.

11. A method as claimed in claim 8, in the event said arranging a transmitter to operate within a limit specified by the regulatory information is unsuccessful, continuing said scanning.

12. A method as claimed in claim 8, wherein said otherwise arranging occurs after all operating channels have been scanned.

13. A method as claimed in claim 8, wherein said otherwise arranging occurs after all operating channels have been scanned and after a predetermined time interval.

14. An article, comprising a storage medium, said storage medium having stored thereon instructions, said instructions, when executed, resulting in establishment of communications over a wireless network by:
scanning for regulatory information broadcast from a local area network;
in the event regulatory information is received, arranging a transmitter to operate within a limit specified by the regulatory information; and
otherwise arranging the transmitter to operate within a predetermined safe power level.

15. An article as claimed in claim 14, wherein said otherwise arranging occurs after a predetermined time interval.

16. An article as claimed in claim 14, further comprising, measuring a background noise of channels scanned during said scanning, said otherwise arranging including arranging the transmitter to operate on a clearer channel.

17. An article as claimed in claim 14, in the event said arranging a transmitter to operate within a limit specified by the regulatory information is unsuccessful, continuing said scanning.

18. An article as claimed in claim 14, wherein said otherwise arranging occurs after all operating channels have been scanned.

19. An article as claimed in claim 14, wherein said otherwise arranging occurs after all operating channels have been scanned and after a predetermined time interval.

20. An apparatus, comprising:
a mobile unit to listen for regulation information broadcast via a wireless local area network; and
a transceiver of the mobile unit, said transceiver to be arranged to operate according to the regulation information when received, and to be arranged to operate at a safe power level when no regulation information is received, said transceiver including a microstrip antenna coupled thereto.

21. An apparatus as claimed in claim 20, the safe power level being within a regulatory limit.

22. An apparatus as claimed in claim 20, said transceiver to be arranged to operate at the safe power level after said mobile unit listens for the regulation information for a predetermined time interval.

23. An apparatus, comprising:
means for scanning for regulatory information broadcast from a local area network; and
means for arranging a transmitter to operate within a limit specified by the regulatory information in the event regulatory information is received, said arranging means otherwise arranging the transmitter to operate within a predetermined safe power level.

24. An apparatus as claimed in claim 23, wherein said arranging means arranges the transmitter to operate within a predetermined safe power level after a predetermined time interval.

25. An apparatus as claimed in claim 23, further comprising means for measuring a background noise of channels scanned during said scanning, wherein said arranging means arranges the transmitter to operate on a clearer channel when said arranging means arranges the transmitter to operate within a predetermined safe power level.

26. An apparatus as claimed in claim 23, said scanning means continues scanning for regulator information in the event arranging the transmitter by said arranging means to operate within a limit specified by the regulatory information is unsuccessful.

27. An apparatus as claimed in claim 23, wherein said arranging means arranges the transmitter to operate at the predetermined safe power level after all operating channels have been scanned.

28. An apparatus as claimed in claim 23, wherein said arranging means arranges the transmitter to operate at the predetermined safe power level after all operating channels have been scanned and after a predetermined time interval.

29. An apparatus, comprising:
a transceiver to scan for regulatory information broadcast from a local area network; and
a processor to arrange a transmitter to operate within a limit specified by the regulatory information in the event regulatory information is received, said processor to otherwise arrange the transmitter to operate within a predetermined safe power level.

30. An apparatus as claimed in claim 29, wherein said processor arranges the transmitter to operate within a predetermined safe power level after a predetermined time interval.

31. An apparatus as claimed in claim 29, further comprising a third structure to measure a background noise of channels scanned during said scanning, wherein said processor arranges the transmitter to operate on a clearer channel when said processor arranges the transmitter to operate within a predetermined safe power level.

32. An apparatus as claimed in claim 29, wherein said transceiver continues to scan for regulatory information in the event arranging the transmitter by said processor to operate within a limit specified by the regulatory information is unsuccessful.

33. An apparatus as claimed in claim 29, wherein said processor arranges the transmitter to operate at the predetermined safe power level after all operating channels have been scanned.

34. An apparatus as claimed in claim 29, wherein said processor arranges the transmitter to operate at the predetermined safe power level after all operating channels have been scanned and after a predetermined time interval.

35. A method, comprising:
establishing communications in a wireless local area network in an infrastructure based services set mode;
determining whether regulatory information is available from the wireless local area network;
in the event regulatory information is available, establishing communications in the wireless local area network in an independent based services set mode according to the regulatory information.

36. A method as claimed in claim 35, in the event no regulatory information is available, determining a clearer channel available in a common band on the wireless local area network, selecting a clearer channel in the common band, and establishing communications in the wireless local area network in an independent based services set mode using the clearer channel.

37. A method as claimed in claim 36, further including communicating at a safe power level.
